(19) United States
(12) Patent Application Publication
(10) Pub. No.: US 2026/0194078 A1
(43) Pub. Date: Jul. 9, 2026

(54) ACTUATING DEVICE FOR A VEHICLE

(71) Applicants: HYUNDAI MOTOR COMPANY, Seoul (KR); KIA CORPORATION, Seoul (KR)

(72) Inventors: Hyun Suk Kim, Hwaseong-si (KR); Seok Hyun Lee, Hwaseong-si (KR)

(73) Assignees: HYUNDAI MOTOR COMPANY, Seoul (KR); KIA CORPORATION, Seoul (KR)

(21) Appl. No.: 19/284,458

(22) Filed: Jul. 29, 2025

(30) Foreign Application Priority Data
Jan. 9, 2025 (KR) 10-2025-0003695

(51) Int. Cl. F15B 13/04; B60K 1/00; F15B 15/14; F16K 11/07

(52) U.S. Cl. CPC F15B 13/0401; B60K 1/00; F15B 15/1447; F16K 11/0716; B60K 2001/006

(57) ABSTRACT

An actuating device for a vehicle includes a motor-driven fluid pump configured to enable normal rotation and reverse rotation of the motor-driven fluid pump. The actuating device also includes an actuating piston configured to generate an operation displacement for switching a driven device between a first state and a second state in accordance with switching of the motor-driven fluid pump between the normal rotation and the reverse rotation.

### CROSS-REFERENCE TO THE RELATED APPLICATION

This application claims priority to Korean Patent Application No. 10-2025-0003695 filed on Jan. 9, 2025 in the Korean Intellectual Property Office, the disclosure of which is incorporated herein by reference in its entirety.

### BACKGROUND OF THE DISCLOSURE

### 1. Field of the Disclosure

The present disclosure relates to technology associated with an actuating device configured to manipulate various devices included in a vehicle.

### 2. Description of the Related Art

A vehicle may typically be equipped with a parking device, a clutch device, a brake device, various locking devices, and the like. An actuating state of such devices is changed by an operational displacement externally input to the device.

Conventional parking systems for a vehicle may be classified into mechanical parking systems and electronic parking systems. A mechanical parking system is configured to mechanically transmit an actuating displacement of a parking lever or the like manipulated by the driver through a cable to a parking device. An electronic parking system is configured to transmit a parking actuating signal initiated by the driver in the form of an electrical signal to a parking device.

In the case of the electronic parking system, the parking device receives a parking actuating signal of the driver in the form of an electrical signal. As such, the parking device should be separately equipped with a parking actuator configured to generate an operation or actuating displacement for realizing an actual parking function.

Meanwhile, an electric vehicle is equipped with a motor-driven fluid pump configured to pump fluid for cooling a drive motor of the vehicle.

The above subject matter disclosed in this section is merely to enhance understanding of the general background of the disclosure. The above should not be taken as an acknowledgement or any form of suggestion that the subject matter forms the related art already known to a person of ordinary skill in the art.

### SUMMARY OF THE DISCLOSURE

The present disclosure has been made in view of the above problems. It is an object of the present disclosure to provide an actuating device for a vehicle that is capable of efficiently and stably manipulating devices, such as a parking device, a clutch device, a brake device, various locking devices, or the like conventionally provided in the vehicle as separate configurations, using a separate motor-driven fluid pump irrespective of the above-described devices. A reduction in the price of the vehicle is thereby achieved.

Objects of the present disclosure are not limited to the above-described object. Other objects of the present disclosure not described herein should be more clearly understood by those of ordinary skill in the art from the following detailed description.

In accordance with an aspect of the present disclosure, the above and other objects can be accomplished by the provision of an actuating device for a vehicle. The actuating device includes a motor-driven fluid pump and an actuating piston. The motor-driven fluid pump is configured to be operated in a normal rotation direction and a reverse rotation direction. The actuating piston is configured to move in or reciprocate through an operation displacement for switching a driven device between a first state and a second state in accordance with switching the motor-driven fluid pump between the normal rotation direction and the reverse rotation direction.

The actuating device may further include a valve assembly having the actuating piston and being configured to slide the actuating piston linearly and reciprocally through the operation displacement in accordance with switching of the motor-driven fluid pump between the normal rotation direction and the reverse rotation direction.

The valve assembly may be configured to continuously maintain the first state or the second state of the driven device, even when the motor-driven fluid pump is stopped or is varied in rate of rotation, once the first state or the second state of the driven device is established.

A fluid receiver may be connected to the valve assembly. The fluid receiver may be configured to receive fluid from the motor-driven fluid pump in a state in which the first state or the second state of the driven device is established.

The driven device may be a parking device of an electric vehicle. The fluid receiver may be a drive motor cooling device of the electric vehicle.

The valve assembly may include a valve body configured to receive the actuating piston such that the actuating piston is linearly slidable. The valve assembly may also include a valve cylinder fixed to the valve body, inserted into the actuating piston at a portion thereof, and configured to guide linear sliding of the actuating piston. The valve assembly may further include a control spool configured to reciprocate linearly in the valve cylinder by a fluid pressure supplied from the motor-driven fluid pump, thereby switching a locking state of the actuating piston with respect to the valve cylinder.

A locking hole may be provided at the valve cylinder to enable the actuating piston, disposed at an outside, and the control spool, disposed at an inside, relative to one another, to communicate with each other. A locking groove may be formed, configured, provided, or disposed at the actuating piston to be aligned with the locking hole in a radial direction of the valve cylinder at a first position at which the actuating piston establishes the first state. A locking medium may be provided at the locking hole to be insertable into the locking groove in accordance with movement thereof in a radial direction of the valve cylinder. An inclined locking surface may be formed, configured, provided, or disposed at the control spool to move the locking medium in the radial direction of the valve cylinder in accordance with linear sliding of the control spool.

An intermediate spring may be provided between the actuating piston and the control spool to apply elastic force in a direction in which the distance between the actuating piston and the control spool increases.

A release spring may be connected to the actuating piston to elastically support the actuating piston in a second direction.

The valve body may include a first port formed, configured, provided, or disposed to supply a fluid pressure pressing the actuating piston in the first direction during the normal rotation of the motor-driven fluid pump. The valve body may include a second port formed, configured, provided, or disposed to receive the fluid pressure in parallel with the first port and to supply the received fluid pressure to the control spool through the valve cylinder. The valve body may also include a third port formed, configured, provided, or disposed to supply, to the fluid receiver, the fluid pressure supplied to the second port and a fourth port formed to supply a fluid pressure pressing the control spool in a second direction during the reverse rotation of the motor-driven fluid pump.

A plurality of cylinder fluid holes may be formed, configured, provided, or disposed at the valve cylinder to communicate with the second port, the third port, and the fourth port in a radial direction, respectively.

The control spool may include a first land formed, configured, provided, or disposed to enable the fluid pressure supplied through the fourth port to press the control spool in the second direction. The control spool may include a third land configured to form or define the inclined locking surface at a circumferential surface thereof. The control spool may also include a second land disposed between the first land and the third land and configured to form or define, between the second land and the first land, a spool groove enabling the second port and the third port to communicate with each other in the first state.

The inclined locking surface of the third land may be formed, configured, provided, or disposed to move the locking medium in an outward radial direction of the valve cylinder as the control spool moves in the first direction.

The first land of the control spool may be formed, configured, provided, or disposed to enable the fourth port to communicate with the third port in the second state and to prevent the fourth port from communicating with the third port in the first state.

The first land of the control spool may be formed, configured, provided, or disposed to enable the fourth port to communicate with an interior of the valve cylinder in the first state.

An end spring may be provided between the first land of the control spool and the valve cylinder to elastically support the first land.

The motor-driven fluid pump may include a first outlet configured to discharge fluid into the first port and the second port during the normal rotation of the motor-driven fluid pump. The motor-driven fluid pump may also include a second outlet configured to discharge fluid into the fourth port during the reverse rotation of the motor-driven fluid pump. A switching valve may be provided between the first outlet of the motor-driven fluid pump and the first and second ports of the valve body to control supply of fluid to the first port and the second port.

The switching valve may be configured, not only to prevent the first port and the second port from communicating with the first outlet and to enable the first outlet to communicate with an outside, for outward drainage of fluid, by a fluid pressure supplied from the second outlet, but also to enable the first outlet to communicate with the first port and the second port by a fluid pressure supplied from the first outlet.

A first suction check valve may be configured to be opened upon suctioning fluid from a fluid pan and may be connected to the first outlet of the motor-driven fluid pump. A second suction check valve may be configured to be opened upon suctioning fluid from the fluid pan and may be connected to the second outlet of the motor-driven fluid pump.

A supply check valve may be configured to be opened only when fluid is supplied to the fluid receiver and may be provided at the third port of the valve body.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a view showing an actuating device for a vehicle according to the present disclosure and with the actuating device in a first state;

FIG. 2 is a cross-sectional view showing an example of an actuating piston usable in the device of FIG. 1;

FIG. 3 is a cross-sectional view showing an example of a valve cylinder usable in the device of FIG. 1;

FIG. 4 is a view showing an example of a control spool usable in the device of FIG. 1;

FIG. 5 is a view showing the actuating device of FIG. 1 being switched from the first state of FIG. 1 to a second state;

FIG. 6 is a view showing the second state of the actuating device of FIG. 1; and

FIG. 7 is a view showing the actuating device of FIG. 1 being switched from the second state of FIG. 6 to the first state of FIG. 1.

### DETAILED DESCRIPTION OF THE EXAMPLE EMBODIMENTS

In the following description of the embodiments of the present disclosure, a detailed description of known technologies incorporated herein has been omitted where it may have obscured the subject matter of the embodiments of the present disclosure. In addition, the embodiments of the present disclosure should be more clearly understood from the accompanying drawings and should not be limited by the accompanying drawings. It should also be appreciated that all changes, equivalents, and substitutes that do not depart from the spirit and technical scope of the present disclosure are encompassed in the present disclosure.

It should be understood that, although the terms “first”, “second”, etc. may be used herein to describe various elements, these elements should not be limited by these terms. These terms are only used to distinguish one element from another.

Unless clearly used otherwise, singular expressions include the plural meaning.

In this specification, the terms “having”, “comprising”, “including”, or the like, are intended to express the existence of the characteristic, the numeral, the step, the operation, the element, the part, or the combination thereof. Such terms do not exclude another characteristic, numeral, step, operation, element, part, or any combination thereof, or any addition thereto.

The suffixes “module” and “unit” of elements herein are used for convenience of description and thus may be used interchangeably and may not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

In addition, the terms “unit”, “control unit”, or the like used in specific terminology are only terms widely used for designating a controller or device for controlling a particular function of a vehicle and, as such, do not mean a generic functional unit.

A controller may include a communication device configured to communicate with another controller or a sensor, to control a function to be performed thereby. A controller may also include a memory configured to store an operating system, logic commands, input/output information, etc., and at least one processor, etc. configured to execute discrimination, calculation, determination, etc. required for control of the function to be performed.

Any number of components or a variety of components of any one of the configurations shown and described in the present disclosure may be included in the present disclosure. Such components may include any combination of characterized parts shown or described in the present disclosure, and may be arranged to constitute any one of various configurations shown or described in the present disclosure. Not only structures and arrangements of the components of the present disclosure, but also concepts as to use and operation thereof, may be applied not only to particular embodiments discussed in the present disclosure, but also to any number of embodiments and in any combinations. In the following description, embodiments including various characterized parts having various arrangements are described with reference to the accompanying drawings.

Hereinafter, various embodiments shown or described in the present disclosure are described in detail with reference to the accompanying drawings. The same or similar elements are designated by the same reference numerals throughout the description and the drawings and redundant description thereof has been omitted. When a component, device, unit, module, controller, element, or the like of the present disclosure is described as having a purpose or performing an operation, function, or the like, the component, device, unit, module, controller, or element should be considered herein as being “configured to” meet that purpose or to perform that operation or function. The present disclosure describes a controller for an actuating device. The controller or other such components may separately embody or be included with a processor and a memory, such as a non-transitory computer readable media, as part of the controller or component.

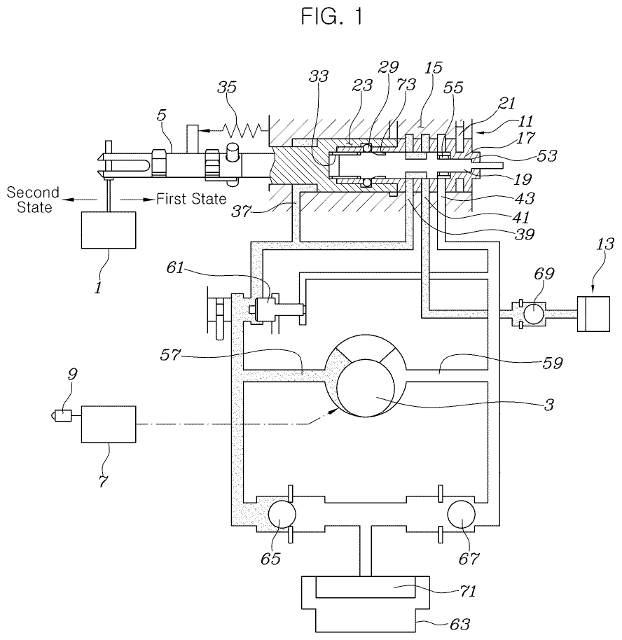

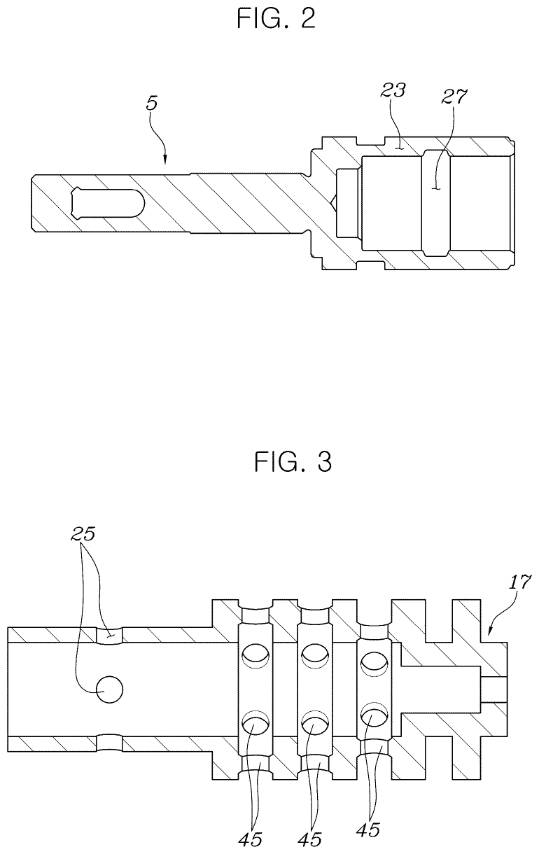

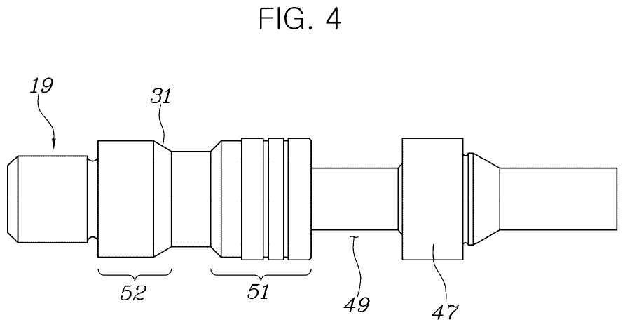

Referring to FIGS. 1-7, an actuating device for a vehicle according to an embodiment of the present disclosure includes a driven device 1, a motor-driven fluid pump 3 rotatable in a normal rotation direction and reverse rotation direction. The actuating device also includes an actuating piston 5 configured to move or reciprocate through an operation displacement for switching the driven device 1 between a first state and a second state in accordance with switching of the motor-driven fluid pump 3 between the normal rotation direction and the reverse rotation direction.

In other words, the actuating device according to the embodiment of the present disclosure is configured to enable the driven device 1 to be switched between the first state and the second state generating an operation displacement of the actuating piston 5 in accordance with switching of the motor-driven fluid pump 3 between the normal rotation direction and reverse rotation direction.

Here, the driven device 1 may be any one or more of a variety of devices conventionally provided in a vehicle so long as each of the devices is configured to be switched between a first state and a second state, which may be random states, in accordance with a reciprocating displacement.

For example, the driven device 1 may be a parking device configured to be switched between a parking state and a parking release state in accordance with a reciprocating displacement. The driven device 1 may be a clutch device configured to be switched between a clutch engaged state and a clutch disengaged or release state in accordance with a reciprocating displacement. The driven device 1 may be a brake device configured to be switched between a braking state and a braking release state in accordance with a reciprocating displacement. The driven device 1 may be various locking devices, each configured to be switched between a locking state and a locking release state in accordance with a reciprocating displacement. The driven device 1 may also be another such device.

In an example, the parking device may be any suitable kind of device configured to establish and maintain a parking state of the vehicle. For example, a parking brake device having a mechanism configured to brake a brake disc by a brake pad or to brake a brake drum by a brake shoe may be used. Also, a parking lock device having a mechanism configured to lock a parking gear, provided in a transmission or a reducer, by a sprag may be used as the parking device.

For reference, the following description is given in conjunction with a case in which the driven device 1 is a parking device of the vehicle.

The operation displacement of the actuating piston 5 is a mechanical movement enabling the driven device 1 as described above to be switched between a state enabling the driven device 1 to establish a first state and to be maintained in the first state and a state enabling the driven device 1 to be released from the first state and to be maintained in the released state, i.e., a second state. For example, the driven device 1 is configured such that, when the actuating piston 5 moves a predetermined linear displacement from an initial home position to a displaced position, the first state of the driven device 1 is established, and such that, when the actuating piston 5 again linearly moves from the displaced position to the original position, the first state of the driven device 1 is released.

In one example, the operation displacement may be constituted by a rotation displacement and not a linear displacement.

The motor-driven fluid pump 3 is configured to be capable of normal rotation and reverse rotation. In other words, the fluid pump may be constructed such that one of two outlets thereof functions as a fluid inlet and the other of the two outlets functions as a fluid outlet to discharge compressed fluid when the fluid pump rotates normally or reversely, and is constructed such that, when the rotation direction of the fluid pump is reversed, the inlet and outlet functions of the two outlets are also reversed.

For reference, switching of the motor-driven fluid pump 3 between normal rotation and reverse rotation is controlled by a controller 7. Rotational speed and/or the like of the motor-driven fluid pump 3 may also be controlled by the controller 7. The controller 7 may be configured such that a parking switch 9 or the like, which receives a parking actuating signal or request of the driver (i.e., is actuated by the driver), is connected to the controller 7. As such, the controller 7 changes a driving direction of the motor-driven fluid pump 3 in accordance with an actuation of the parking switch 9 by the driver, thereby switching the driven device 1 between a first state and a second state.

In the present embodiment, the vehicle actuating device includes a valve assembly 11 having the actuating piston 5 while being configured to slide the actuating piston 5 linearly and reciprocally. Thus, the actuating piston 5 forms the above-described operation displacement in accordance with switching of the motor-driven fluid pump 3 between the normal rotation direction and the reverse rotation direction.

In other words, the valve assembly 11 is configured to establish the first state and the second state of the driven device 1 by enabling the actuating piston 5 to move according to the operation displacement. This movement may be achieved by a fluid pressure supplied from the motor-driven fluid pump 3 in accordance with switching of the motor-driven fluid pump 3 between the normal rotation direction and reverse rotation direction.

Here, the position to which the actuating piston 5 moves such that the driven device 1 is switched to the first state is referred to as a “first position”. Likewise, the position to which the actuating piston 5 moves such that the driven device 1 is switched to the second state is referred to as a “second position”. In addition, the direction in which the actuating piston 5 moves toward the first position is referred to as a “first direction”. Likewise, the direction in which the actuating piston 5 moves toward the second position is referred to as a “second direction”.

For reference, when the driven device 1 is a parking device, the first state means a parking state and the second state means a parking release state. Also, the first position means a parking position and the second position means a parking release position. Further, the first direction means a direction in which the parking device moves to the parking position and the second direction means a direction in which the parking device moves to the parking release position.

The valve assembly 11 is configured to continuously maintain the first state or the second state of the driven device 1 even when the motor-driven fluid pump 3 is stopped or is varied in rate of rotation, once the first state or the second state of the driven device 1 is established.

In addition, a fluid receiver 13 is connected to the valve assembly 11. The fluid receiver 13 is configured to receive fluid from the motor-driven fluid pump 3 in a state in which the first state or the second state of the driven device 1 is established.

That is to say, the valve assembly 11 is configured, not only to switch the driven device 1 between the first state and the second state in accordance with switching of the motor-driven fluid pump 3 between the normal rotation direction and the reverse rotation direction, but also to independently supply, to the fluid receiver 13, fluid discharged from the motor-driven fluid pump 3, irrespective of the driven device 1, once the first state or the second state is established.

Accordingly, the motor-driven fluid pump 3 is configured, not only to perform a function for supplying fluid to the fluid receiver 13, but also to perform a function of generating an operation displacement of the driven device 1.

In particular, the valve assembly 11 is configured to continuously maintain the first state or the second state of the driven device 1 in a situation in which the driven device 1 has been switched to the first state or the second state. The valve assembly 11 does so while preventing the driven device 1 from being switched to the first state or the second state even in variation of the motor-driven fluid pump 3 such as stop of the motor-driven fluid pump 3, a variation in rate of rotation of the motor-driven fluid pump 3, and/or the like. As such, in the above-described situation, the valve assembly 11 enables the motor-driven fluid pump 3 to be driven only at the request of the fluid receiver 13.

The fluid receiver 13 may be constituted by a drive motor cooling device of an electric vehicle.

That is to say, the electric vehicle generates drive force thereof by the drive motor and, as such, it is necessary to cool heat generated from the drive motor. To this end, fluid discharged from the motor-driven fluid pump 3, which is used to generate an operation displacement of the driven device 1, may be used to cool the drive motor.

Accordingly, the controller 7 may adjust the rate of rotation of the motor-driven fluid pump 3 in accordance with a temperature of the drive motor such that the motor-driven fluid pump 3 supplies fluid in a suitable amount required for cooling of the drive motor. In addition, in a situation in which the temperature of the drive motor is very low, the controller 7 may control the motor-driven fluid pump 3 to stop immediately after the driven device 1 establishes the first state or the second state and to be continuously maintained in the established state even when the motor-driven fluid pump 3 is driven to generate an operation displacement of the driven device 1.

The fluid receiver 13 may be employed as any device required to receive fluid, in addition to the above-described device. For example, the fluid receiver 13 may be employed as a battery cooling device, a power electric (PE) system cooling device including an inverter, or the like.

The valve assembly 11 may include a valve body 15 configured to receive the actuating piston 5 such that the actuating piston 5 is linearly slidable. The valve assembly 11 may also include a valve cylinder 17 fixed to the valve body 15, inserted into the actuating piston 5 at a portion thereof, and configured to guide linear sliding of the actuating piston 5. The valve assembly 11 may further include a control spool 19 configured to reciprocate linearly in the valve cylinder 17 by fluid pressure supplied from the motor-driven fluid pump 3. Thus, a locking state of the actuating piston 5 may be switched with respect to the valve cylinder 17.

In other words, in the valve assembly 11, the valve cylinder 17 is fixed to the valve body 15 by a fixing clip 21. The actuating piston 5 is installed at the valve body 15 to be coaxial with the valve cylinder 17 and to be linearly slidable. In addition, the control spool 19 is installed in the valve cylinder 17 coaxially with the actuating piston 5 to be linearly slidable.

In addition, a skirt 23 is configured to allow the valve cylinder 17 and the control spool 19 to be insertable therein and is formed at the actuating piston 5. Accordingly, when the actuating piston 5 slides linearly, the skirt 23 may slide linearly in a space formed between the valve body 15 and the valve cylinder 17.

A locking hole 25 is provided at the valve cylinder 17 to enable the actuating piston 5, disposed at the outside, and the control spool 19, disposed at the inside, to communicate with each other. A locking groove 27 is formed at the actuating piston 5 to be aligned with the locking hole 25 in a radial direction of the valve cylinder 17 at the first position at which the actuating piston 5 establishes the first state. A locking medium 29 is provided at the locking hole 25 to be insertable into the locking groove 27 in accordance with movement thereof in the radial direction of the valve cylinder 17. An inclined locking surface 31 is formed at the control spool 19 to move the locking medium 29 in the radial direction of the valve cylinder 17 in accordance with linear sliding of the control spool 19.

That is to say, a state in which the locking medium 29 is inserted into both the valve cylinder 17 and the actuating piston 5 is established when the locking medium 29, provided at the locking hole 25 of the valve cylinder 17, is inserted into the locking groove 27 as the locking medium 29 moves in an outward radial direction by the inclined locking surface 31 of the control spool 19 in a state in which the actuating piston 5 is positioned at the first position. Accordingly, the actuating piston 5 is locked with respect to the valve cylinder 17 and the valve body 15. Thus, the actuating piston 5 is continuously maintained at the first position unless the control spool 19 moves. Accordingly, the first state of the driven device 1 may be stably maintained.

An intermediate spring 33 may be provided between the actuating piston 5 and the control spool 19 to apply elastic force in a direction in which the distance between the actuating piston 5 and the control spool 19 increases. The intermediate spring 33 functions to press the control spool 19 when the actuating piston 5 is positioned at the first position, as described above. This enables the inclined locking surface 31 of the control spool 19 to continuously and stably maintain the state in which the locking medium 29 is inserted into the locking groove 27 of the actuating piston 5.

The locking medium 29, in one example, may be a ball, multiple balls, a roller, multiple rollers, or the like installed at the valve cylinder 17. The locking medium 29 is configured to repetitively establish states thereof protruding from and retracting into the locking groove 27 of the actuating piston 5 in accordance with reciprocating movement of the inclined locking surface 31.

Further, a release spring 35 is connected to the actuating piston 5 to elastically support the actuating piston 5 in the second direction.

The release spring 35 is installed to apply elastic force to the actuating piston 5. This enables the actuating piston 5 to move smoothly such that the actuating piston 5 is rapidly released from the first state, when the actuating piston 5 moves to a release position of the driven device 1 as the actuating piston 5 is released from a state locked by the locking medium 29.

The vehicle equipped with the actuating device according to the present disclosure may provide rapid responsiveness when the first state is released.

The valve body 15 includes a first port 37 formed to supply a fluid pressure pressing the actuating piston 5 in the first direction during normal rotation of the motor-driven fluid pump 3. The valve body 15 includes a second port 39 formed to receive the fluid pressure in parallel with the first port 37 and to supply the received fluid pressure to the control spool 19 through the valve cylinder 17. The valve body 15 also includes a third port 41 formed to supply, to the fluid receiver 13, the fluid pressure supplied to the second port 39. The valve body 15 further includes a fourth port 43 formed to supply a fluid pressure pressing the control spool 19 in the second direction during reverse rotation of the motor-driven fluid pump 3.

In addition, a plurality of cylinder fluid holes 45 is formed at the valve cylinder 17 to communicate with the second port 39, the third port 41, and the fourth port 43 in a radial direction, respectively.

In other words, the valve cylinder 17 is fixedly inserted into an interior of the valve body 15 to cover portions of the valve body 15 formed with the second port 39, the third port 41, and the fourth port 43. The valve cylinder 17 is also provided with the plurality of cylinder fluid holes 45 in order to enable an interior thereof to communicate with the second port 39, the third port 41, and the fourth port 43. The valve cylinder 17 may be configured to be integrated with the valve body 15, so long as it is unnecessary to take machinability or assemblability into consideration.

The control spool 19 includes a first land 47 formed to enable the fluid pressure supplied through the fourth port 43 to press the control spool 19 in the second direction. The control spool 19 includes a third land 52 configured to form the inclined locking surface 31 at a circumferential surface thereof. The control spool 19 also includes a second land 51 disposed between the first land 47 and the third land 52 and configured to form, between the second land 51 and the first land 47, a spool groove 49 enabling the second port 39 and the third port 41 to communicate with each other in the first state.

In this case, the inclined locking surface 31 of the third land 52 is formed to move the locking medium 29 in the outward radial direction of the valve cylinder 17 as the control spool 19 moves in the first direction.

Accordingly, as described above, the intermediate spring 33 is installed to elastically support the control spool 19 in the first direction with respect to the actuating piston 5.

The first land 47 of the control spool 19 is formed to enable the fourth port 43 to communicate with the third port 41 in the second state and to prevent the fourth port 43 from communicating with the third port 41 in the first state.

In addition, the first land 47 of the control spool 19 is formed to enable the fourth port 43 to communicate with the interior of the valve cylinder 17 in the first state.

In other words, as illustrated in FIG. 1, a step 53 is formed at a right end of the control spool 19 to prevent additional movement of the control spool 19 in a right direction by the valve cylinder 17. In this state, the first land 47 of the control spool 19 does not block the cylinder fluid hole 45 communicating with the fourth port 43. Accordingly, when a fluid pressure is supplied to the fourth port 43, the supplied fluid pressure may be directly exerted on the first land 47.

Accordingly, the control spool 19 may supply fluid, which is supplied to the fourth port 43, to the fluid receiver 13 through the third port 41 in the second state of the driven device 1. In the first state of the driven device 1, the fluid pressure supplied to the fourth port 43 may be smoothly and reliably exerted on the first land 47.

In addition, an end spring 55 may be provided between the first land 47 of the control spool 19 and the valve cylinder 17 to elastically support the first land 47.

The end spring 55 performs a buffering function by elastically supporting the first land 47 when the control spool 19 moves in the first direction.

The motor-driven fluid pump 3 includes a first outlet 57 configured to discharge fluid into the first port 37 and the second port 39 during normal rotation of the motor-driven fluid pump 3. The fluid pump 3 includes a second outlet 59 configured to discharge fluid into the fourth port 43 during reverse rotation of the motor-driven fluid pump 3. A switching valve 61 is provided between the first outlet 57 of the motor-driven fluid pump 3 and the first and second ports 37 and 39 of the valve body 15 to control supply of fluid to the first port 37 and the second port 39.

That is to say, the switching valve 61 is configured to prevent the first port 37 and the second port 39 from communicating with the first outlet 57 and to enable the first outlet 57 to communicate with the outside, for outward drainage of fluid, by a fluid pressure supplied from the second outlet 59. The switching valve 61 is also configured to enable the first outlet 57 to communicate with the first port 37 and the second port 39 by a fluid pressure supplied from the first outlet 57.

A first suction check valve 65, which is configured to be opened upon suctioning fluid from a fluid pan 63, is connected to the first outlet 57 of the motor-driven fluid pump 3. A second suction check valve 67, which is configured to be opened upon suctioning fluid from the fluid pan 63, is connected to the second outlet 59 of the motor-driven fluid pump 3.

Accordingly, when the motor-driven fluid pump 3 is driven in the normal rotation direction, the second suction check valve 67 is opened such that fluid from the fluid pan 63 is suctioned into the second outlet 59, and the first suction check valve 65 is closed by a fluid pressure discharged into the first outlet 57. On the other hand, when the motor-driven fluid pump 3 is driven in the reverse rotation direction, the first suction check valve 65 is opened such that fluid from the fluid pan 63 is suctioned into the first outlet 57, and the second suction check valve 67 is closed by a fluid pressure discharged into the second outlet 59.

A supply check valve 69, which is configured to be opened only when fluid is supplied to the fluid receiver 13, may be provided at the third port 41 of the valve body 15.

In addition, the first suction check valve 65 and the second suction check valve 67 may be configured to suction fluid from the fluid pan 63 through a fluid filter 71.

Hereinafter, switching between the first state and the second state in an actuating device of the present disclosure, configured as described above, is described.

FIG. 1 shows that the actuating device is in the first state. In this state, the actuating piston 5 is positioned at the first position and the inclined locking surface 31 of the control spool 19 presses the locking medium 29 in the outward radial direction of the valve cylinder 17. Thus, the locking medium 29 is inserted between the locking hole 25 of the valve cylinder 17 and the locking groove 27 of the actuating piston 5. Accordingly, the actuating piston 5 is locked with respect to the valve cylinder 17 in spite of the elastic force of the release spring 35. As a result, the first state is stably maintained.

In this state, the motor-driven fluid pump 3 rotates in the normal rotation direction and, thus, fluid is discharged through the first outlet 57. The fluid discharged from the first outlet 57 is supplied to the first port 37 and the second port 39. The fluid supplied to the second port 39 is supplied to the fluid receiver 13 through the third port 41.

When the rate of rotation of the motor-driven fluid pump 3 increases or decreases in the above-described situation, the amount of fluid supplied to the fluid receiver 13 through the third port 41 increases or decreases. Accordingly, the controller 7 controls the motor-driven fluid pump 3 in order to supply an amount of fluid required by the fluid receiver 13.

Even when a fluid pressure supplied to the first port 37 is varied or released as the rate of rotation of the motor-driven fluid pump 3 is varied as described above, or driving of the motor-driven fluid pump 3 itself is stopped, the actuating piston 5 is maintained in a state of being locked with respect to the valve cylinder 17 by the control spool 19 and the locking medium 29. As a result, the first state of the driven device 1 may be stably maintained.

In particular, as shown in FIG. 1, the intermediate spring 33 may realize a self-locking function by elastically supporting the control spool 19 in the first direction with respect to the actuating piston 5. Thus, the first state may be stably maintained even when vibration, impact, or the like is applied from the outside in a state in which the fluid pressure of the first port 37 is released due to stop of the motor-driven fluid pump 3.

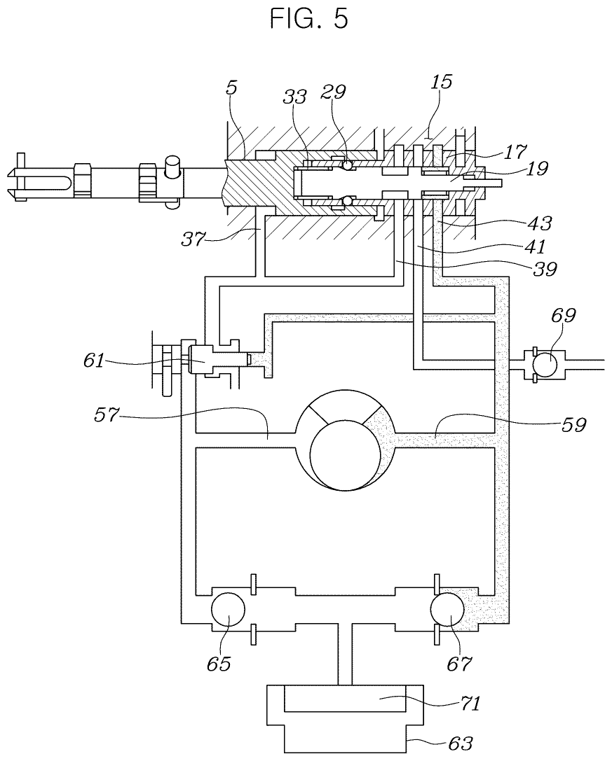

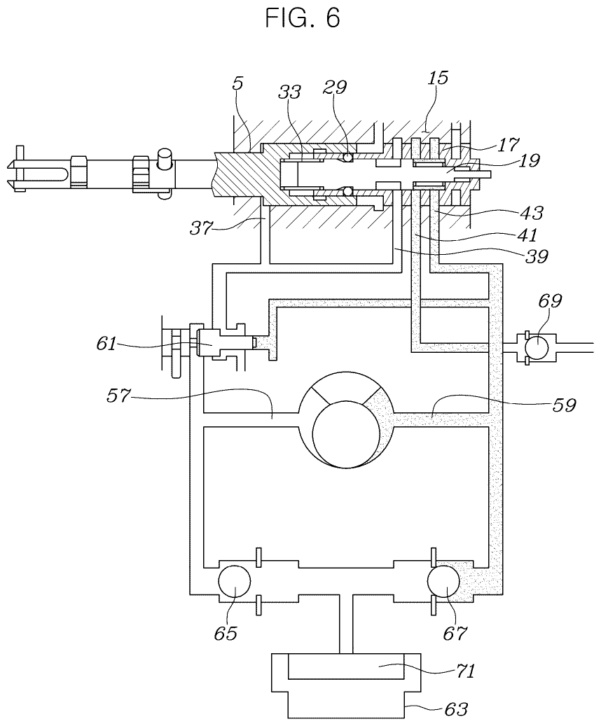

Switching from the first state to the second state as described above may be expressed as switching from the state shown in FIG. 1 to the state shown in FIG. 6 via the state shown in FIG. 5.

In other words, when the driver of the vehicle applies a signal for switching from the first state to the second state by actuating or manipulating the parking switch 9, the controller 7 drives the motor-driven fluid pump 3 in the reverse rotation direction such that the motor-driven fluid pump 3 suctions fluid through the first outlet 57 and then discharges the fluid through the second outlet 59, as shown in FIG. 5.

Accordingly, the first suction check valve 65 connected to the first outlet 57 is opened, and the second suction check valve 67 connected to the second outlet 59 is closed. As a result, fluid discharged from the second outlet 59 is supplied to the fourth port 43 while being supplied to the switching valve 61. As a result, the control spool 19 is pressed in the second direction and the first port 37 and the second port 39 is blocked from the first outlet 57. This causes the fluid pressure supplied to the first port 37 and the second port 39 to be released.

As the control spool 19 moves in the second direction, the locking medium 29, which has been pressed by the inclined locking surface 31, enters a state in which the locking medium 29 is movable in an inward radial direction. The actuating piston 5 also moves in the second direction by the elastic force of the release spring 35, thereby moving the locking medium 29 in the inward radial direction of the valve cylinder 17. As a result, the state in which the actuating piston 5 is locked with respect to the valve cylinder 17 is released and, as a result, the actuating piston 5 may freely move to the release position, thereby entering the second state as shown in FIG. 6.

In the second state of FIG. 6, the first land 47 of the control spool 19 is positioned at a position enabling the fourth port 43 to communicate with the third port 41 while blocking the fourth port 43 from the second port 39. This is because the locking medium 29 moves between the inclined locking surface 31 of the control spool 19 and the step 73 while protruding toward an inside of the valve cylinder 17 by an inner diameter portion of the skirt 23 of the actuating piston 5. This prevents the control spool 19 from further moving in the second direction.

Accordingly, the fluid supplied to the fourth port 43 may be stably supplied to the fluid receiver 13 through the third port 41.

In the second state of FIG. 6 as described above, the control spool 19 does not move even when the fluid pressure supplied to the fourth port 43 is varied in accordance with a variation in rotational speed of the motor-driven fluid pump 3. As a result, the controller 7 may freely control the motor-driven fluid pump 3 in accordance with an amount of fluid required by the fluid receiver 13.

In addition, since the control spool 19 does not move, even when driving of the motor-driven fluid pump 3 is stopped, the controller 7 may be independently driven only for the fluid receiver 13 irrespective of the driven device 1.

In order to prevent the control spool 19 from moving in a state in which a fluid pressure is not applied to the first land 47 of the control spool 19 through the fourth port 43 as driving of the motor-driven fluid pump 3 is stopped, the intermediate spring 33 should not press the control spool 19 in the first direction. Accordingly, it may be advantageous that the intermediate spring 33 be configured to have a length at which the intermediate spring 33 cannot press the control spool 19 when the actuating piston 5 is positioned at the release position, as shown in FIG. 6.

In order to again switch the driven device 1 from the second state as described above to the first state as shown in FIG. 1, the controller 7 should control the motor-driven fluid pump 3 to rotate in the normal rotation direction in accordance with the driver actuating the parking switch 9.

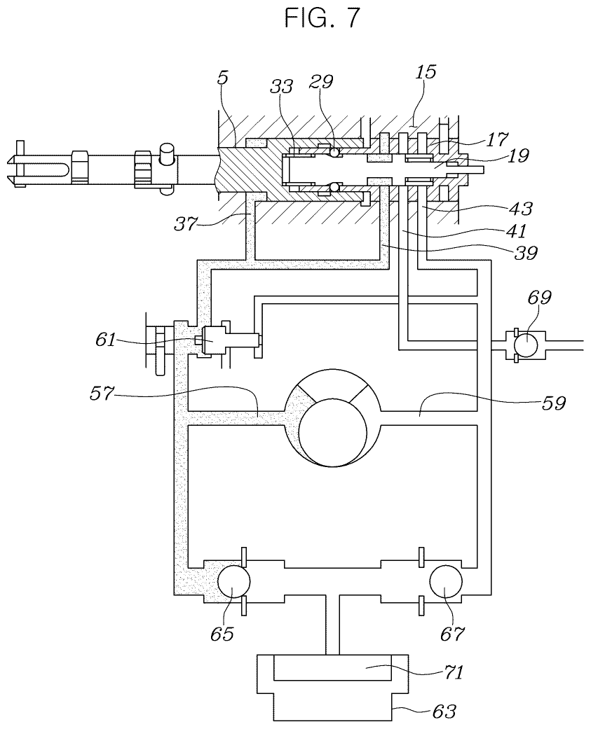

That is to say, when the motor-driven fluid pump 3 rotates in the normal rotation direction in the state of FIG. 6, the motor-driven fluid pump 3 suctions fluid into the second outlet 59 through the second suction check valve 67, and then discharges the suctioned fluid into the first outlet 57. The fluid discharged through the first outlet 57 manipulates the switching valve 61 while blocking the first suction check valve 65 and, as a result, is supplied to the first port 37 and the second port 39, as shown in FIG. 7.

The fluid supplied to the first port 37 presses the actuating piston 5 in the first direction against the elastic force of the release spring 35. This moves the actuating piston 5 to the first position as shown in FIG. 1. In this state, the fourth port 43 is connected to the second outlet 59 and, thus, enters a negative pressure state. In addition, as the actuating piston 5 moves, the intermediate spring 33 presses the control spool 19 in the first direction and, as a result, the control spool 19 moves in the first direction.

Accordingly, the inclined locking surface 31 of the control spool 19 moves the locking medium 29 in the outward radial direction of the valve cylinder 17 such that the locking medium 29 is inserted into the locking groove 27 of the actuating piston 5. This locks the actuating piston 5 with respect to the valve cylinder 17 and the valve body 15. Thus, the first state of the driven device 1 is stably obtained.

As should be apparent from the above description, in accordance with the present disclosure, it is possible to efficiently and stably manipulate a parking device, a clutch device, a brake device, various locking devices, and/or the like that are conventionally provided in a vehicle as separate configurations, using a separate motor-driven fluid pump of the vehicle irrespective of the above-described devices. A reduction in the price of the vehicle is thus achieved.

Effects attainable by the technical concepts of the present disclosure are not limited to the above-described effects. Other effects of the present disclosure that are not described herein may be more clearly understood by those of ordinary skill in the art from the above description.

Although the example embodiments of the present disclosure have been disclosed for illustrative purposes, those having ordinary skill in the art should appreciate that various modifications, additions, and/or substitutions are possible, without departing from the scope and spirit of the disclosure as defined in the accompanying claims.

What is claimed is:

1. An actuating device for a vehicle, the actuating device comprising:
a motor-driven fluid pump configured to operate in a normal rotation direction and a reverse rotation direction; and
an actuating piston configured to reciprocate through an operation displacement for switching a driven device between a first state and a second state in accordance with switching of the motor-driven fluid pump between the normal rotation direction and the reverse rotation direction.

2. The actuating device according to claim 1, further comprising:
a valve assembly including the actuating piston and configured to slide the actuating piston linearly and reciprocally through the operation displacement in accordance with switching of the motor-driven fluid pump between the normal rotation direction and the reverse rotation direction.

3. The actuating device according to claim 2, wherein the valve assembly is configured to continuously maintain the first state or the second state of the driven device despite the motor-driven fluid pump being stopped or being varied in rate of rotation, once the first state or the second state of the driven device is established.

4. The actuating device according to claim 3, wherein:
a fluid receiver is connected to the valve assembly; and
the fluid receiver is configured to receive fluid from the motor-driven fluid pump in a state in which the first state or the second state of the driven device is established.

5. The actuating device according to claim 4, wherein:
the driven device is a parking device of an electric vehicle; and
the fluid receiver is a drive motor cooling device of the electric vehicle.

6. The actuating device according to claim 2, wherein the valve assembly comprises:
a valve body configured to receive the actuating piston such that the actuating piston is linearly slidable;
a valve cylinder fixed to the valve body, inserted into the actuating piston at a portion thereof, and configured to guide linear sliding of the actuating piston; and
a control spool configured to reciprocate linearly in the valve cylinder by a fluid pressure supplied from the motor-driven fluid pump,
wherein a locking state of the actuating piston switches with respect to the valve cylinder according to movement of the control spool.

7. The actuating device according to claim 6, wherein:
a locking hole is provided at the valve cylinder to enable the actuating piston and the control spool to communicate with each other;
a locking groove is disposed at the actuating piston to be aligned with the locking hole in a radial direction of the valve cylinder at a first position at which the actuating piston establishes the first state;
a locking medium is provided at the locking hole to be insertable into the locking groove in accordance with movement thereof in a radial direction of the valve cylinder; and
an inclined locking surface is disposed at the control spool to move the locking medium in the radial direction of the valve cylinder in accordance with linear sliding of the control spool.

8. The actuating device according to claim 7, wherein an intermediate spring is provided between the actuating piston and the control spool to apply elastic force in a direction in which a distance between the actuating piston and the control spool increases.

9. The actuating device according to claim 8, wherein a release spring is connected to the actuating piston to elastically support the actuating piston in a second direction.

10. The actuating device according to claim 7, wherein the valve body comprises:
a first port provided to supply a fluid pressure pressing the actuating piston in the first direction as the motor-driven fluid pump is rotated in the normal rotation direction;
a second port provided to receive the fluid pressure in parallel with the first port and to supply the received fluid pressure to the control spool through the valve cylinder;
a third port provided to supply, to a fluid receiver configured to receive fluid, the fluid pressure supplied to the second port; and
a fourth port provided to supply a fluid pressure pressing the control spool in a second direction as the motor-driven fluid pump is rotated in the reverse rotation direction.

11. The actuating device according to claim 10, wherein a plurality of cylinder fluid holes is provided at the valve cylinder to communicate with the second port, the third port, and the fourth port in a radial direction, respectively.

12. The actuating device according to claim 11, wherein the control spool comprises:
a first land disposed to enable the fluid pressure supplied through the fourth port to press the control spool in the second direction;
a third land configured to define the inclined locking surface at a circumferential surface thereof; and
a second land disposed between the first land and the third land and configured to define, between the second land and the first land, a spool groove enabling the second port and the third port to communicate with each other in the first state.

13. The actuating device according to claim 12, wherein the inclined locking surface of the third land is configured to move the locking medium in an outward radial direction of the valve cylinder as the control spool moves in the first direction.

14. The actuating device according to claim 12, wherein the first land of the control spool is configured to enable the fourth port to communicate with the third port in the second state and to prevent the fourth port from communicating with the third port in the first state.

15. The actuating device according to claim 14, wherein the first land of the control spool is configured to enable the fourth port to communicate with an interior of the valve cylinder in the first state.

16. The actuating device according to claim 15, wherein an end spring is provided between the first land of the control spool and the valve cylinder to elastically support the first land.

17. The actuating device according to claim 11, wherein:
the motor-driven fluid pump comprises i) a first outlet configured to discharge fluid into the first port and the second port as the motor-driven fluid pump is rotated in the normal rotation direction and ii) a second outlet configured to discharge fluid into the first port as the motor-driven fluid pump is rotated in the reverse rotation direction; and
a switching valve is provided between the first outlet of the motor-driven fluid pump and the first and second ports of the valve body to control supply of fluid to the first port and the second port.

18. The actuating device according to claim 17, wherein the switching valve is configured to:
prevent the first port and the second port from communicating with the first outlet and to enable the first outlet to communicate with an outside, for outward drainage of fluid, by a fluid pressure supplied from the second outlet; and
enable the first outlet to communicate with the first port and the second port by a fluid pressure supplied from the first outlet.

19. The actuating device according to claim 17, wherein:
a first suction check valve is configured to be opened upon suctioning fluid from a fluid pan and is connected to the first outlet of the motor-driven fluid pump; and
a second suction check valve is configured to be opened upon suctioning fluid from the fluid pan and is connected to the second outlet of the motor-driven fluid pump.

20. The actuating device according to claim 11, wherein a supply check valve is configured to be opened only when fluid is supplied to the fluid receiver and is provided at the third port of the valve body.
